(19) United States
(12) Patent Application Publication
(10) Pub. No.: US 2014/0007400 A1
(43) Pub. Date: Jan. 9, 2014

(54) SYSTEM AND METHOD FOR REMOVING WHEEL RIMS FROM DUAL WHEEL VEHICLES

(71) Applicant: Luiz Correa Neto, Framingham, MA (US)

(72) Inventor: Luiz Correa Neto, Framingham, MA (US)

(73) Assignee: Heads Up Tools, Hopedale, MA (US)

(21) Appl. No.: 13/771,131

(22) Filed: Feb. 20, 2013

Related U.S. Application Data
(60) Provisional application No. 61/601,382, filed on Feb. 21, 2012.

(51) Int. Cl. B60B 29/00

(52) U.S. Cl. CPC B60B 29/008
USPC 29/426.5; 29/239

(57) ABSTRACT

A system and method for removing adjacent rims from dual wheel vehicles is provided. The system and method involve the use of a specialized tool that comprises a threaded bolt, a pusher assembly coupled to one end of the threaded bolt, and a puller assembly threadably connected to the bolt proximate the other end and separated a prescribed distance from the pusher assembly. The pusher assembly has an engagement face configured to engage an outer edge of a wheel rim or a surface of a rotor or drum. The puller assembly has a shoulder portion with an engagement surface configured to also engage with an edge of the adjacent wheel rim. As the threaded bolt is rotated, the pusher assembly remains in a general stationary orientation while the puller assembly moves axially along the threaded bolt away from the pusher assembly to loosen or separate the wheel rim.

### CROSS REFERENCE TO RELATED APPLICATIONS

This application claims the benefit of and priority to U.S. provisional patent application Ser. No. 61/601,382 filed on Feb. 21, 2012; the disclosure of which is incorporated by reference herein.

### FIELD OF THE INVENTION

The present invention relates to a method and system for repair and maintenance of dual wheel vehicles, and more particularly, a method and system for removing wheel rims of dual wheel vehicles such as trucks, buses, vans, limousines and recreational vehicles to facilitate the maintenance and repair thereof.

### BACKGROUND

Wheel rim assemblies on dual wheel vehicles have been known to seize together from the accumulation of dirt, dust, moisture, and from corrosion over time as well as from bonding interactions between the wheel assembly components that can occur over time from various forces and loads. The problem of seized or stuck wheel assembly components is especially common in dual wheel vehicles and other heavy duty vehicles.

When faced with the problem of stuck or seized wheel rim assemblies, mechanics and repair technicians generally resort to the use of a pry bar, hammer, and/or mallet to separate or loosen stuck wheel rims or other components. Removing the seized components of dual wheel or other heavy duty vehicles can take significant amount of time as well as dozens of forceful hammer blows to the rotor, and occasionally requires the use of a torch to create temperature differentials across and between the seized parts. Unfortunately such techniques typically impart unevenly applied impact forces, which may deform or damage the wheel assembly components such as the hub, rotor, bearings, axle, etc. Such techniques can also result in injury to the mechanics and repair technicians.

Prior art devices or tools for removing stuck or seized wheel assembly components include large pulling devices and attempt to pull the stuck components apart by securing pulling devices to the wheels or the wheel assembly studs or lugs. Alternate types of dual wheel removing tools are disclosed in U.S. Pat. Nos. 4,709,474; and 5,426,841. Such tools and devices are not easy to use and the forces imparted by these large pulling devices can result in deformation and damage to the studs or lugs and to the wheel assembly. Such damage usually requires replacement of the deformed and damaged parts, which further adds to the labor and maintenance costs. In addition, the cost and size of many such pulling devices or tools make it impractical to use in many repair situations.

Despite their best efforts, the technicians and mechanics often cannot avoid irreparable damage to the wheel assembly components during removal, the costs of which are borne by the vehicle owner. What is needed therefore is a small, simple and inexpensive means to safely loosen or remove stuck or seized wheel rims from a dual wheel vehicle that is both compact in size and easy to use.

### SUMMARY OF THE INVENTION

The present invention may be characterized as a too comprising: a threaded bolt; a pusher assembly coupled to an end of the threaded bolt; and a puller assembly threadably connected to the threaded bolt and separated a prescribed distance from the pusher assembly. The pusher assembly has a generally cylindrical body portion and an engagement face disposed proximate a distal end of the body portion. The engagement face is configured to engage an outer edge of a wheel rim or a surface of a rotor or drum. The puller assembly also has a generally cylindrical body portion with a threaded bore for coupling to the threaded bolt and also has a shoulder portion with an engagement surface configured to couple or engage with an edge of a wheel rim. As the threaded bolt is rotated, the pusher assembly remains in a general stationary orientation while the puller assembly moves axially along the bolt away from the pusher assembly.

The engagement face of the pusher assembly may comprises a plurality of surfaces to engage multiple items, such as both an edge of a wheel rim and the surface of the rotor or drum using the same pusher assembly. While the pusher assembly illustrated and described herein is preferably a unitary structure, it is contemplated that some embodiments may be comprised two or more components assembled together.

Similarly, the shoulder of the puller assembly may comprise various engagement surfaces configured to engage different items. Preferably, the engagement surface on the shoulder of the puller assembly is configured to form a clasp type or grasp type coupling with the edge of a wheel rim as the threaded bolt is rotated. Again, the puller assembly is preferably a unitary structure, some embodiments may be comprised of two or more assembled components (e.g. shoulder portion and body portion).

The present invention may also be characterized as a method for removing rims of a dual wheeled vehicle using a rim separating tool. The rim separating tool comprise: a threaded bolt; a pusher assembly coupled to an end of the threaded bolt, the pusher assembly having a body and an engagement face disposed proximate a distal end of the body and configured to engage an edge of a first wheel rim or a surface of a rotor; and a puller assembly threadably connected to the threaded bolt, the puller assembly having a threaded body and a shoulder with an engagement surface configured to couple or engage with an edge of a second wheel rim. Using an assembled rim separator tool, the present method for removing rims of a dual wheeled vehicle comprises the steps of; (b) inserting distal end of the adjustable rim separator assembly with the pusher assembly into a rim opening on the dual wheeled vehicle; (c) aligning the engagement face of the pusher assembly with an edge of a first rim so that the engagement face of the pusher assembly abutting engagement with the edge of the first rim; (d) positioning the puller assembly such that the engagement surface on the shoulder of the puller assembly is coupled to an edge of a second or adjacent rim while maintaining the abutting engagement between the pusher assembly and the edge of the first rim; (e) rotating the threaded bolt using a power tool or hand tool, wherein as the threaded bolt is rotated, the pusher assembly remains in a general stationary orientation while the puller assembly moves axially along the threaded bolt away from the pusher assembly to separate the first rim from the wheel; and (f) removing the rim separator assembly from the rim opening on the dual wheeled vehicle.

The above-identified steps (b) through (f) may be repeated as needed at an alternate location on the first rim using another rim opening until the first rim is removed. In situations where the second rim is also required to be removed, the present method may further comprise the steps of: (g) aligning the engagement face of the pusher assembly with a surface of a rotor of the dual wheeled vehicle so that the engagement face of the pusher assembly is in an abutting engagement with the surface of the rotor; (h) positioning the puller assembly such that the engagement surface on the shoulder of the puller assembly is coupled to an edge of a second or adjacent rim while maintaining the abutting engagement between the pusher assembly and the surface of the rotor; (i) rotating the threaded bolt using a power tool or hand tool, wherein as the threaded bolt is rotated, the pusher assembly remains in a general stationary orientation while the puller assembly moves axially along the threaded bolt away from the pusher assembly to separate the second rim from the wheel; and (j) removing the rim separator assembly. The above-identified steps (g) through (j) may also be repeated, as needed, at an alternate location on the second rim until it is removed.

In another aspect, the present invention may be characterized as a system for removing wheel rims from a dual wheeled vehicle, the system comprising: an adjustable rim separator assembly having a connecting rod, a first separating element and a second separating element. The adjustable rim separator assembly is disposed between an edge of a first wheel rim or a surface of a rotor and an edge of a second wheel rim; and a power tool or hand tool adapted to rotate the connecting rod of the adjustable rim separator assembly, wherein the first separating element and second separating element move away from one another in an axial direction along the axis of the connecting rod as the connecting rod is rotated by the power tool or hard tool. The preferred adjustable rim separator assembly comprises a connecting rod configured to be rotated about an axis; a first separating element coupled to the connecting rod and further configured to be in abutting engagement with the edge of the first wheel rim or a surface of the rotor; and a second separating element coupled to the connecting rod and further disposed in abutting engagement with an edge of the second wheel rim. More preferably, the adjustable rim separator tool is the same as the tool described above.

### BRIEF DESCRIPTION OF THE DRAWINGS

While the specification concludes with claims distinctly pointing out the subject matter that applicants regard as their invention, it is believed that the invention will be better understood when taken in connection with the accompanying drawings in which:

FIG. 1 is across sectional view of an embodiment of the tool used for removing rims from dual wheeled vehicles in accordance with the present invention;

FIG. 2 is a cross sectional view of another smaller embodiment of the tool used for removing rims from dual wheeled vehicles in accordance with the present invention;

FIG. 3 is a side view of the pusher assembly shown in FIGS. 1 and 2;

FIG. 4 is a partial cut-away perspective view of the engagement face of the pusher assembly of FIGS. 1-3;

FIGS. 5A and 5B are a side view and top view, respectively of the puller assembly used in the embodiment shown in FIG. 1;

FIGS. 6A and 6B are a side view and top view, respectively of an alternate embodiment of the puller assembly used in the embodiment shown in FIG. 2.

### DETAILED DESCRIPTION

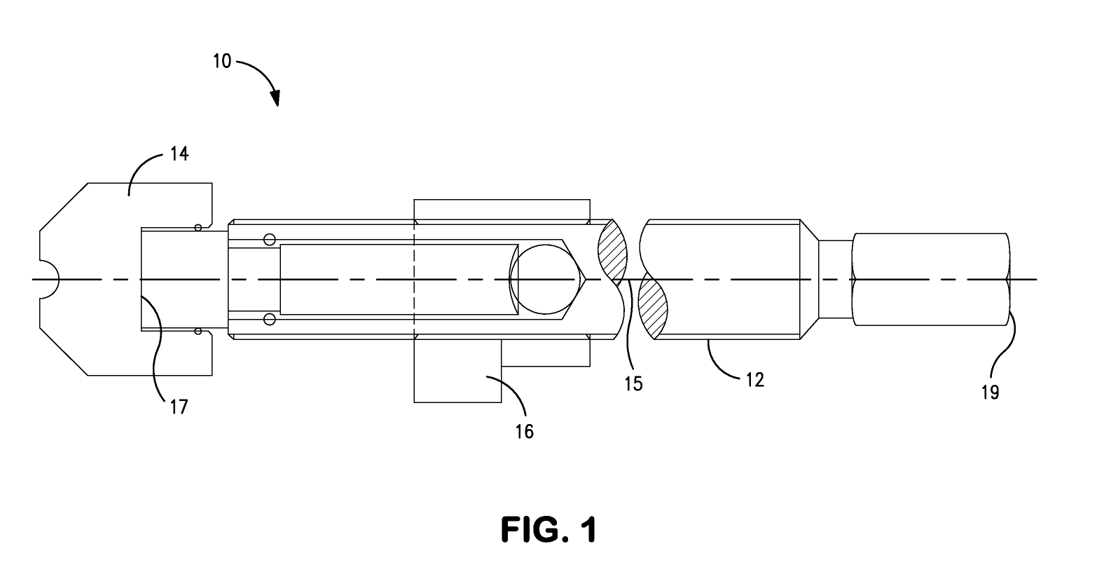

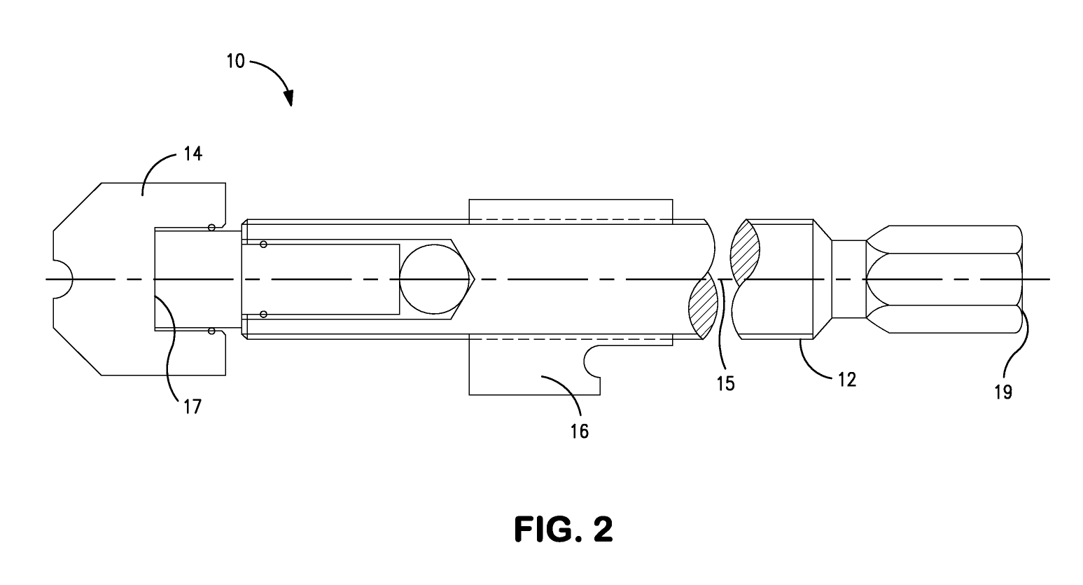

Turning to FIGS. 1 and 2, there are shown two embodiments of the tool used for removing wheel rims from dual wheeled vehicles. The illustrated tools 10 include a threaded bolt 12; a pusher assembly 14; and a puller assembly 16. The threaded bolt 12 (or connecting rod) is shown as a standard ball joint bolt. The pusher assembly 14 (or first separating element) is adapted to fit on a first end 17 of the threaded bolt 12 Whereas the puller assembly 16 (or second separating element) is threadably attached to the bolt 12 via the second end 19 of the threaded bolt 12. As illustrated, the pusher assembly 14 and the puller assembly 16 are axially separated from one another along the central axis 15 of the threaded bolt 12.

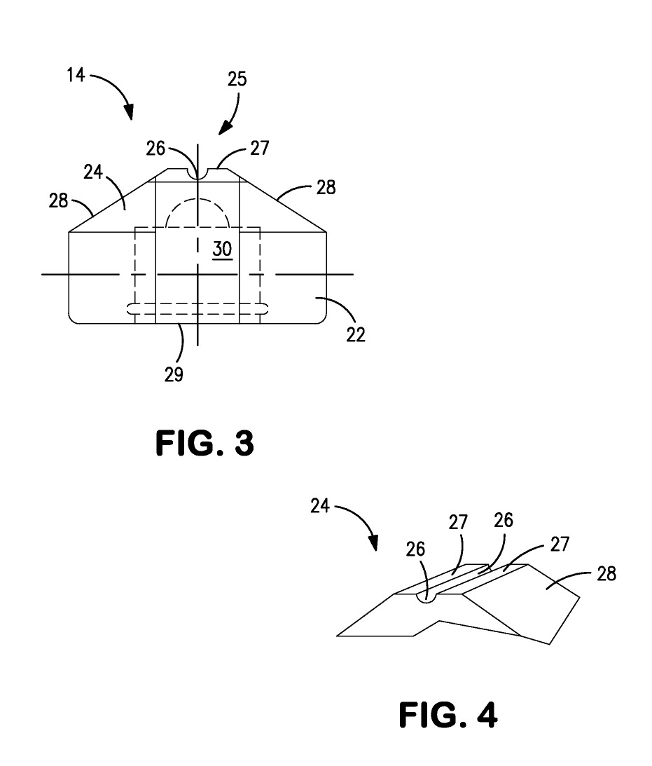

As seen more clearly in FIGS. 3 and 4, the pusher assembly 14 has a body portion 22 and an engagement face portion 24. Although illustrated as a unitary structure, it is contemplated that the pusher assembly could be constructed of multiple inter-connected components. The engagement face portion 24 of the pusher assembly 14 is disposed proximate a distal end 25 of the pusher assembly 14 and body portion 22. The engagement face portion 24 includes an engagement surface or surfaces 26, 27 that are configured to engage an edge of a wheel rim or a surface of a rotor or drum. Specifically, engagement surface 26 is preferably a notch or groove configured to engage an edge of a wheel rim (not shown) whereas engagement surface 27 is a flat surface configured to abuttingly engage a surface of a rotor or drum (not shown). The engagement face portion 24 also includes angles surfaces 28 from the body portion 22 to the engagement surfaces 26, 27 to provide a clearance that facilitates proper engagement between the engagement surfaces 26, 27 and the edge of a wheel rim or surface of a rotor or drum. The body portion 22 of the pusher assembly 14 is a generally cylindrical structure with a central cavity 30 into which the first end 17 of the threaded bolt 12 is inserted and retained. The end 17 of the threaded bolt 12 retained in the cavity 30 with the aid of a retaining groove formed within the cavity near the proximate end 29 of the pusher assembly 14 and a standard O-ring inserted in the retaining groove. Using this arrangement, the pusher assembly 14 remains generally in a stationary orientation as the threaded bolt is rotated.

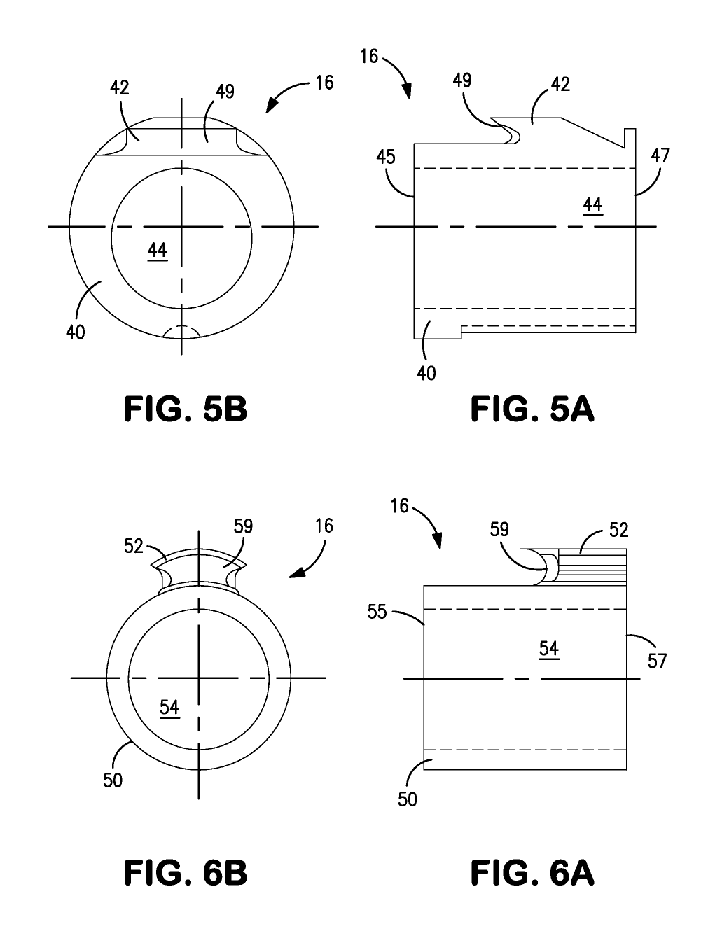

Turning now to FIGS. 5A and 5B, the puller assembly 16 includes a body portion 40 and a shoulder portion 42. The body portion 40 is a generally cylindrical structure with a threaded bore 44 passing therethrough and is adapted to be threadably connected to the threaded ball joint bolt 12. The body portion 40 of the puller assembly further includes a front or distal end 45 designed to face the pusher assembly 14 when the tool is assembled and a back end or proximate end 47. The shoulder portion 42 includes an engagement surface 49 or structure facing the back end or proximate end 47 and is configured to couple or engage with an edge of a wheel rim. As the threaded bolt 12 is ted or driven, the puller assembly 16, including the body portion 40 and shoulder portion 42, moves axially along the threaded bolt 12 away from the pusher assembly 14. As described in more detail below, the engagement surface 49 of the shoulder portion 42 preferably forms a clasp type or grasp type coupling with the edge of a wheel rim as the threaded bolt 12 is rotated.

FIGS. 6A and 6B shows an alternate embodiment of the puller assembly 16 that also includes a body portion 50 and a shoulder portion 52. Except for the dimensions, the body portion 50 is similar to the body portion 40 in the embodiment described with reference to FIGS. 5A and 5B, including front and back ends 55, 57 and a central bore 54. The illustrated shoulder portion 52, however, is slightly different arrangement configured to couple or engage with an edge of a different sized wheel rims such as small holed rims. The engagement surface 59 or structure facing the back end or proximate end 57 is a formed as an arcuate groove. As the threaded bolt 12 is rotated, the puller assembly 16, including the body portion 50 and shoulder portion 52 moves axially along the threaded bolt 12 away from the pusher assembly 14 and engages the edge of a wheel rim (not shown). As the threaded bolt continues to be rotated, the separation of the pusher assembly 14 and puller assembly 16 pushes and/or pulls the rims of the dual wheeled vehicle thereby loosening or separating the rim.

Although the puller assembly 16 illustrated in FIGS. 5A, 5B, 6A, and 6B are shown as unitary structures, it is contemplated that the puller assemblies could also be constructed of multiple inter-connected components. For example, the shoulder portion can be envisioned as a sleeve surrounding and connected to the body portion of the puller assembly or as a separate extension that snaps or connects to the body portion.

The preferred method of removing rims/wheels from a dual wheel vehicle begins with several preparation steps including lubricating the dual wheels by applying penetration oil around and between the hub and lug nuts of the dual wheels to be removed. The next preparation step is to remove several lug nuts securing the rim and wheel to the vehicle leaving a few lug nuts loosely attached to the outer rim to prevent the wheel from falling to the ground. The final preparation step is to assemble the tool by first attaching the appropriately sized puller assembly to the threaded bolt and then attaching the pusher assembly to the end of the threaded bolt.

The preferred removal process involves first removing the outer rim and wheel from the vehicle followed by removal of the inner rim and wheel. To remove the outer rim, the assembled tool is inserted into a rim opening and the engagement face of the pusher assembly is positioned in an abutting engagement to the lip of the inner rim. The puller assembly is then aligned such that the engagement surface of the shoulder grasps or clasps the lip of the outer rim. Alignment of the puller assembly is preferably accomplished by hand tightening or screwing the puller assembly along the threaded bolt until full engagement or coupling with the lip of the outer rim.

Once the tool is aligned, the threaded bolt is rotated or driven to loosen the outer rim and wheel using an air power tool such as an impact driver. If an impact driver is not available. use of a hand tool such as a wrench or ratchet to rotate the threaded bolt may be attempted. Upon loosening or partially separating the outer rim at this first location, the tool is removed. The process can be repeated at an alternate location on the outer rim using another rim opening until the outer rim and wheel can be easily removed. The remaining lug nuts are removed and the outer rim and wheel is removed from the hub.

Once the outer rim and wheel are removed, the tool is then used to loosen the inner rim and wheel. Again, the process is started by ensuring a few lug nuts are loosely attached to the inner rim to prevent the rim and Wheel from falling to the ground. The assembled rim separation tool is then inserted into a rim opening on the inner rim. The engagement face of the pusher assembly is positioned on a surface of the rotor and the puller assembly is subsequently aligned such that the engagement surface of the shoulder grasps or clasps the lip of the inner rim. As indicated above, alignment of the puller assembly is preferably accomplished by hand tightening or screwing the puller assembly along the threaded bolt until engagement with the lip of the inner rim.

Once the rim separating tool is aligned, the threaded bolt is driven or rotated to loosen the inner rim using an impact driver or other power drive tool. Upon loosening or partially separating the outer rim, the tool is removed and repositioned at an alternate location on the outer rim using another rim opening where the steps of tool alignment and driving the threaded bolt are repealed. Continue this process until the inner rim and wheel can be easily removed. The lug nuts are then removed allowing the outer and wheel to be removed.

While the present invention has been characterized in various ways and described in relation to the preferred embodiments and preferred methods, numerous, additions, changes and modifications thereto can be made to the disclosed system and method without departing from the spirit and scope of the present invention as set forth in the appended claims. For example, the disclosed tool and method can be used or adapted to spread apart items that are stuck or frozen together other than wheel rims on a dual wheeled vehicle.

What is claimed is:

1. An tool comprising:
a threaded bolt;
a pusher assembly coupled to an end of the threaded bolt, the pusher assembly having a body and an engagement face disposed proximate a distal end of the body and configured to engage an edge of a wheel rim or a surface of a rotor or drum; and
a puller assembly threadably connected to the threaded bolt, the puller assembly having a threaded body and a shoulder with an engagement surface configured to couple or engage with an edge of a wheel rim;
wherein as the threaded bolt is rotated, the pusher assembly remains in a general stationary orientation while the puller assembly moves axially along the threaded bolt away from the pusher assembly.

2. The tool of claim 1 wherein the engagement face of the pusher assembly further comprises a plurality of surfaces configured to engage the edge of a wheel rim and the surface of the rotor or drum.

3. The tool of claim 1 wherein the engagement surface on the shoulder of the puller assembly forms a clasp type or grasp type coupling with the edge of a wheel rim as the threaded bolt is rotated.

4. The tool of claim 1 wherein the pusher assembly is a unitary structure.

5. The tool of claim 1 wherein the puller assembly is a unitary structure.

6. A method for removing wheel rims from adjacent wheels of a dual wheeled vehicle, the method comprising the steps of:
(a) assembling a rim separator tool, the rim separator tool comprising a threaded bolt; a pusher assembly coupled to an end of the threaded bolt, the pusher assembly having a body and an engagement face disposed proximate a distal end of the body and configured to engage an edge of a first wheel rim or a surface of a rotor; and a puller assembly threadably connected to the threaded bolt, the puller assembly having a threaded body and a shoulder with an engagement surface configured to couple or engage with an edge of a second wheel rim;
(b) inserting the distal end of the rim separator tool with e pusher assembly into a rim opening on the dual wheeled vehicle;
(c) aligning the engagement face of the pusher assembly with an edge of a first rim of the dual wheeled vehicle so that the engagement face of the pusher assembly is in an abutting engagement with the edge of the first rim;
(d) positioning the puller assembly such that the engagement surface on the shoulder of the puller assembly is coupled to an edge of a second or adjacent rim of the dual wheeled vehicle while maintaining the abutting engagement between the pusher assembly and the edge of the first rim;
(e) rotating the threaded bolt using a power tool or hand tool, wherein as the threaded bolt is rotated, the pusher assembly remains in a general stationary orientation while the puller assembly moves axially along the threaded bolt away from the pusher assembly to separate the first rim from the wheel; and
(f) removing the rim separator tool from the rim opening on the dual wheeled vehicle.

7. The method of claim 6 further comprising repeating steps (b) through (f) at an alternate location on the first rim using another rim opening until the first rim is removed.

8. The method of claim 6 further comprising the steps of:
(g) aligning the engagement face of the pusher assembly with a surface of a rotor of the dual wheeled vehicle so that the engagement face of the pusher assembly is in an abutting engagement with the surface of the rotor;
(h) positioning the puller assembly such that the engagement surface on the shoulder of the puller assembly is coupled to an edge of a second or adjacent rim of the dual wheeled vehicle while maintaining the abutting engagement between the pusher assembly and the surface of the rotor;
(i) rotating the threaded bolt using a power tool or hand tool, wherein as the threaded bolt is rotated, the pusher assembly remains in a general stationary orientation while the puller assembly moves axially along the threaded bolt away from the pusher assembly to separate the second rim from the wheel; and
(j) removing the rim separator assembly.

9. The method of claim 8 further comprising repeating steps (g) through (i) at an alternate location on the second rim until the second rim is removed.

10. A system for removing wheel ms from a dual wheeled vehicle, the system comprising:
a rim separator assembly disposed between an edge of a first wheel rim or a surface of a rotor and an edge of a second wheel rim;
the adjustable rim separator assembly comprising a connecting rod configured to be rotated about an axis; a first separating element coupled to the connecting rod and further configured to be in abutting engagement with the edge of the first wheel rim or a surface of the rotor; and a second separating element coupled to the connecting rod and further disposed in abutting engagement with an edge of the second wheel rim;
a power tool or hand tool adapted to rotate the connecting rod of the adjustable rim separator assembly, wherein the first separating element and second separating element move away from one another in an axial direction along the axis of the connecting rod as the connecting rod is rotated by the power tool or hard tool.

11. The system of claim 10 wherein the first separating element and second separating element can be positioned along the connecting rod.

12. The system of claim 10 wherein the connecting rod is a threaded bolt, the first separating element is coupled to an end of the threaded bolt, the second separator element is threadably connected to the threaded bolt, and wherein as the threaded bolt is rotated, the first separating element remains in a general stationary orientation while the second separating element moves axially along the threaded bolt away from the first separating element.

13. The system of claim 10 wherein the first separator element is a pusher assembly having a body and an engagement face disposed proximate a distal end of the body and configured to engage the edge of the first wheel rim or a surface of a rotor.

14. The system of claim 13 wherein the engagement face of the pusher assembly further comprises a plurality of surfaces configured to engage the edge of the first wheel rim and the surface of the rotor.

15. The system of claim 13 wherein the pusher assembly is a unitary structure.

16. The system of claim 10 wherein the second first separator element is a puller assembly having a body and a shoulder with an engagement surface configured to couple or engage with the edge of the second wheel rim.

17. The system of claim 16 wherein the engagement surface on the shoulder of the puller assembly forms a clasp type or grasp type coupling with the edge of the second wheel rim as the connecting rod is rotated.

18. The system of claim 16 wherein the puller assembly is a unitary structure.
